(19) United States
(12) Patent Application Publication
(10) Pub. No.: US 2023/0052885 A1
(43) Pub. Date: Feb. 16, 2023

(54) Method and Device for Making Sensor Data More Robust Against Adverse Disruptions

(71) Applicant: Volkswagen Aktiengesellschaft, Wolfsburg (DE)

(72) Inventors: Peter Schlicht, Wolfsburg (DE); Fabian Hüger, Wolfenbüttel (DE)

(73) Assignee: Volkswagen Aktiengesellschaft, Wolfsburg (DE)

(21) Appl. No.: 17/786,302

(22) PCT Filed: Dec. 10, 2020
(86) PCT No.: PCT/EP2020/085650

§ 371 Date: Aug. 29, 2022

(30) Foreign Application Priority Data
Dec. 17, 2019 (DE) 10 2019 219 923.2

(51) Int. Cl. B60W 60/00; G06K 9/62

(52) U.S. Cl. CPC B60W 60/001; G06K 9/6289; B60W 2420/42; B60W 2420/52

(57) ABSTRACT

The disclosure relates to a method for making sensor data more robust to adversarial perturbations, wherein sensor data are obtained from at least two sensors, wherein the sensor data obtained from the at least two sensors are replaced in each case piecewise by means of quilting, wherein the piecewise replacement is carried out in such a way that the respectively replaced sensor data from different sensors are plausible relative to one another, and wherein the sensor data replaced piecewise are output.

### CROSS-REFERENCE TO RELATED APPLICATIONS

This application claims priority to German Patent Application No. DE 10 2019 219 923.2, filed on Dec. 17, 2019 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The invention relates to a method and device for making sensor data more robust to adversarial perturbations. The invention further relates to a method for operating an assistance system for a vehicle, to an assistance system for a vehicle, to a computer program, and to a data carrier signal.

Machine learning, for example on the basis of neural networks, has great potential for use in modern driver assistance systems and automated motor vehicles. Functions based on deep neural networks process sensor data (for example from cameras, radar or lidar sensors) to derive relevant information therefrom. This information comprises, for example, a type and a position of objects in an environment of the motor vehicle, a behavior of the objects, or a road geometry or topology.

Among neural networks, convolutional neural networks (CNN), in particular, have proven particularly suitable for applications in image processing. Convolutional neural networks extract various valuable features from input data (e.g., image data) in stages in an unsupervised manner. During a training phase, the convolutional neural network independently develops feature maps based on filter channels that process the input data locally in order to hereby derive local properties. These feature maps are then processed again by other filter channels that derive more valuable feature maps therefrom. Based on this information condensed in this way from the input data, the deep neural network finally derives its decision and provides same as output data.

Whereas convolutional neural networks are superior to classic approaches in terms of functional accuracy, they also have disadvantages. For example, attacks based on adversarial perturbations in the sensor data/input data can result in misclassification or, alternatively, incorrect semantic segmentation in spite of semantically unaltered content in the recorded sensor data.

A quilting method for eliminating adversarial perturbations in image data is known from Chuan Guo et al., Countering Adversarial Images Using Input Transformations, axViv:1711.00117v3 [cs.CV], 25 Jan. 2018, https://arxiv.org/pdf/1711.00117.pdf.

### SUMMARY

A need exists to improve a method and a device for making sensor data more robust to adversarial perturbations, in particular with regard to the use of multiple sensors as well as sensor data fusion. The need is addressed by the subject matter of the independent claims. Embodiments of the invention are described in the dependent claims, the following description, and the drawings.

### BRIEF DESCRIPTION OF THE DRAWINGS

FIG. 1 is a schematic representation of an embodiment of a device for making sensor data more robust to adversarial perturbations and an embodiment of an assistance system;

FIG. 2 is a schematic representation for illustrating quilting;

FIG. 3 is a schematic representation for illustrating the quilting according to an embodiment of the method described in this disclosure.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method is provided for making sensor data more robust to adversarial perturbations, wherein sensor data are obtained from at least two sensors, wherein the sensor data obtained from the at least two sensors are replaced in each case piecewise by means of quilting, wherein the piecewise replacement is carried out in such a way that respectively replaced sensor data from different sensors are plausible relative to one another, and wherein the sensor data replaced piecewise are output.

Furthermore, in some embodiments, a device is provided for making sensor data more robust to adversarial perturbations, said device comprising a computing apparatus, wherein the computing apparatus is configured to obtain sensor data from at least two sensors, to replace the sensor data obtained from the at least two sensors in each case piecewise by means of quilting, and to carry out the piecewise replacement in such a way that respectively replaced sensor data from different sensors are plausible relative to one another, and to output the sensor data replaced piecewise.

The method and the device make it possible, if multiple—i.e. at least two—sensors are used, to make the sensor data provided by the multiple sensors more robust to adversarial perturbations. For this purpose, the sensor data of the at least two sensors are replaced in each case piecewise by means of quilting. The piecewise replacement takes place in such a way that the sensor data replaced piecewise are plausible relative to one another (across sensors). In particular, during the quilting, sensor data patches used for the piecewise replacement are selected in such a way that respective temporally and spatially corresponding replaced sensor data of the at least two sensors are plausible relative to one another. If the sensor data made more robust in this manner are then fed, for example, to a neural network as input data, an adversarial perturbation originally contained in the obtained sensor data will have lost its effect, without semantic content in the sensor data having been altered. Due to the fact that a plausibility between the sensor data of the at least two sensors is maintained, the piecewise replacement does not alter a content-related link, in particular a spatial and temporal link or, alternatively, a correlation, between the sensor data of the at least two sensors. This is beneficial, in particular, if sensor data fusion takes place after the method is carried out.

The quilting in particular comprises the piecewise replacement of sensor data, which can also be referred to as piecewise reconstruction of the sensor data (in connection with image data the term “image quilting” is also used). In particular, the sensor data may be of any type, i.e., the quilting is not restricted to two-dimensional image data. A set of replaced sensor data forms or, alternatively, is comprised by a reconstruction data domain. If, for example, said data are images of a camera, the camera image is split into multiple segments. In most cases, small rectangular image sections (also referred to as patches) are defined for this purpose. The individual segments or, alternatively, image sections are compared with segments, referred to in the following as sensor data patches, which are stored in a database, for example. The sensor data patches may also be referred to as data blocks. The sensor data patches in particular form subsymbolic subsets of previously recorded sensor data of the same type, wherein it is certain that the sensor data were free from adversarial perturbations. The comparison takes place on the basis of a distance measure that is defined, for example, by a Euclidean distance on pixel vectors or sensor data vectors. For this purpose, a segment or, alternatively, image section is linearized as a vector. A distance is then determined by means of a vector space norm, for example the L2 norm. The segments or, alternatively, image sections are in each case replaced by the closest or, alternatively, most similar sensor data patch from the database. In this connection, it can be provided that a minimum distance must be adhered to or, alternatively, that the segment from the sensor data and the sensor data patch at least may not be identical. The piecewise replacement takes place analogously if the sensor data are in another form (e.g., lidar data) or, alternatively, in another format. In particular, the piecewise replacement takes place for all segments of the recorded sensor data, such that replaced or rather reconstructed sensor data are then available. After the piecewise replacement, i.e., after the quilting, an effect of the adversarial perturbations in the replaced or rather reconstructed sensor data is eliminated or at least reduced.

A “plausibility” of replaced sensor data is, in particular, intended to mean that the replaced sensor data are physically plausible relative to one another. In particular, in this connection, a probability that the respectively replaced sensor data in the respectively selected combination would also occur under real conditions, i.e., in the real world, is intended to be as high as possible (in the sense of a maximum likelihood, for example). Put simply, the replaced sensor data of the at least two sensors are intended to be selected in such a way that the probability that these sensor data in this combination would also occur in reality is maximized. If, for example, the at least two sensors are a camera and a lidar sensor, plausibility between the respectively replaced sensor data means that a particular image section in the replaced camera data and a spatially and temporally corresponding segment from the replaced lidar data are selected in such a way that the sensor data are consistent with one another, i.e., physically free of contradictions. In the example given above, in which the at least two sensors are a camera and a lidar sensor, the segments of the sensor data are in each case replaced in such a way that each replaced image section corresponds in each case to a replaced segment of the lidar data, as would also occur with a high probability if sensor data of the camera and of the lidar sensor were recorded at the same time.

The at least two sensors are, in particular, spatially and temporally calibrated with one another, such that the sensor data of the at least two sensors spatially and temporally correspond with one another or, alternatively, have common temporal and spatial points of reference.

The sensor data of the at least two sensors may, in principle, be one-dimensional or multi-dimensional, in particular two-dimensional. For example, the sensor data may be two-dimensional camera images of a camera and two-dimensional or three-dimensional lidar data of a lidar sensor. In principle, however, the sensor data may also come from other sensors, for example radar sensors or ultrasound sensors, etc.

The obtained sensor data are, in particular, sensor data that are recorded and/or output for a function for the automated or partially automated driving of a vehicle and/or for sensing the environment.

A vehicle is, in particular, a motor vehicle. In principle, however, the vehicle may be any other land, air, water, rail or space vehicle, for example a drone or an air taxi.

An adversarial perturbation is, in particular, a targeted perturbation of the input data of a neural network, for example provided in the form of sensor data, wherein semantic content in the input data is not altered, but the perturbation results in the neural network inferring an incorrect result, i.e., it performs a misclassification or incorrect semantic segmentation of the input data, for example.

A neural network is, in particular, a deep neural network, in particular a convolutional neural network (CNN). For example, the neural network is or has been trained for a specific function, for example for a function of an assistance system of a vehicle, in particular for automated or partially automated driving and/or for sensing the environment, for example for sensing pedestrians or other objects in the recorded camera images.

The method is, in particular, repeated cyclically, such that replaced sensor data can be provided, in particular continuously, for obtained sensor data of a sensor data flow.

The method may also be designed as a computer-implemented method. In particular, the method may be executed by means of a data processing apparatus. The data processing apparatus comprises, in particular, at least one computing apparatus and at least one memory apparatus.

A computer program is in particular also provided, comprising commands which, upon execution of the computer program by a computer, prompt said computer to execute the method steps of the disclosed method according to any of the embodiments described.

Furthermore, a data carrier signal is in particular also provided, which transmits the above-mentioned computer program.

Parts of the device, in particular the computing apparatus, may be designed separately or collectively as a combination of hardware and software, for example as program code which is executed on a microcontroller or microprocessor. However, it is also possible for parts to be designed separately or collectively as an application-specific integrated circuit (ASIC).

It can be provided that the method comprises the recording of the sensor data by means of the at least two sensors.

In some embodiments, it is provided that the sensor data replaced piecewise are fed to at least one function for the automated or partially automated driving of a vehicle and/or for sensing the environment. As a result, the at least one function can be fed sensor data that have been made more robust, such that a functionality provided by the at least one function can also be made more robust. The sensor data replaced piecewise are fed to the at least one function and the at least one function in particular generates at least one control signal and/or evaluation signal based on the sensor data replaced piecewise and provides said signal. Thus, in particular, an output of the at least one function in the form of the at least one control signal and/or evaluation signal can be generated and provided in a more reliable manner. The at least one control signal and/or evaluation signal may, for example, be used to control actuators of the vehicle in an open-loop or closed-loop manner and/or may be processed further within the scope of automated or partially automated driving, for example for trajectory planning. The at least one function is, in particular, a function that is provided by means of a method of machine learning and/or artificial intelligence. For example, the at least one function may be provided by means of a trained artificial neural network.

In some embodiments, it is provided that a database having sensor data patches generated from sensor data of the at least two sensors is provided for the quilting, wherein the sensor data patches of the at least two sensors are linked with one another in the database in such a way that the respectively linked sensor data patches are plausible relative to one another. As a result, a plausibility between replaced sensor data can be made possible in a particularly efficient manner.

The sensor data patches, which are used for the piecewise replacement of the sensor data of the at least two sensors, may be stored in the database for example in the form of common database entries. For example, the sensor data patches for the at least two sensors may already be combined into vectors and stored in the database. If, for example, the sensors are a camera and a lidar sensor, the sensor data patches of the camera, i.e., individual image sections used for the replacement, can be combined with respective sensor data patches corresponding thereto in a physically plausible manner, i.e., segments of lidar data, to form common vectors. Each pixel of the camera is then assigned an item of depth information derived from the lidar data. If, for example, image sections of 8×8 pixels each are considered, one vector with 256 entries results in each case for three color channels and one depth signal: 8×8×(3+1)=256. Each entry in the database then comprises one vector of this kind. The sensor data of the at least two sensors are then combined analogously to the stored vectors, such that a distance from the vectors stored in the database can be determined using a distance measure, for example the L2 norm. The vector from the database that has the shortest distance from a vector to be replaced is used for the replacement during the quilting. The database is created, in particular, on the basis of recorded sensor data (recorded previously, independently of the disclosed method), wherein the sensor data of the at least two sensors are, in particular, recorded simultaneously, wherein the sensors are spatially and temporally calibrated with one another. In the process, trustworthy sensor data are used, i.e., sensor data in which it is certain that no adversarial perturbations are present. For example, training data of a (deep) neural network may be used here, to which neural network the (replaced) sensor data are to be fed during an application phase. The sensor data patches are generated from these trustworthy sensor data and stored in the database. If the at least two sensors are other types of sensors, the procedure is analogous.

In some embodiments, it is provided that a selection of sensor data patches used during the quilting is made for the at least two sensors based on the sensor data of only a portion of the at least two sensors. In particular, it can be provided that a selection of a sensor data patch for replacing sensor data of the at least two sensors is made based on obtained sensor data of only one of the sensors. As a result, for example, a computing power required for searching can be reduced, since a comparison with sensor data patches in the database only takes into account the sensor data of the one sensor, for example. When the sensor data patch with the shortest distance from the sensor data of the one sensor has been found, the sensor data patches of the other or, alternatively, others of the at least two sensors can also be derived from the sensor data patch that was found without another search on account of the link that is present. This makes it possible to accelerate a search in the database. In the example given above, in which sensor data patches are stored in the database with an associated item of depth information as image sections of a camera comprising 8×8 pixels, it can for example be provided that a comparison with the sensor data patches in the database only takes place for the image sections, wherein the associated entries in the vector are subsequently directly used for the lidar data to replace the lidar data. Alternatively, the comparison or, alternatively, the search for the closest sensor data patch may also take place on the basis of the lidar data, wherein, after the sensor data patch is found, the associated image section is acquired from the entries of the vector. Overall, the comparison or, alternatively, the search in the database can be accelerated. Since the sensor data patches stored in the database for the at least two sensors are linked with one another in a plausible manner, there is no loss of quality during the quilting or, alternatively, in the replaced sensor data of the at least two sensors in spite of the accelerated search. The replaced sensor data of the at least two sensors are still plausible relative to one another after the quilting.

In some embodiments, it is provided that at least one item of identification information is obtained, wherein the piecewise replacement during the quilting additionally takes place in consideration of the at least one obtained item of identification information. An item of identification information can also be referred as a tag or label. As a result, for example, the entries in the database, i.e., the sensor data patches stored therein, can be marked with additional information such that they can be found more quickly later. In particular, it can be provided that the database is indexed using a hash function such that a search in the database can be accelerated, since a number of entries of the database can already be reduced prior to a comparison with the sensor data of the at least two sensors by means of a preselection.

In some embodiments, it is provided that the obtained item of identification information is or has been derived from an item of contextual information relating to an environment in which the sensor data of the at least two sensors are or were recorded. An item of contextual information may, for example, comprise a geographical coordinate (e.g., GPS coordinate), a time of day and/or year, a month, a day of the week, a weather condition (sun, rain, fog, snow, etc.) and/or a traffic context (city, countryside, highway, pedestrian zone, country road, main road, side road, etc.). As a result, firstly, the quality of the sensor data replaced piecewise can be improved, since a context in which the sensor data were recorded can be taken into account during the piecewise replacement. In particular, sensor data patches can be stored in the database so as to be marked (“tagged”) with at least one item of contextual information. Secondly, a preselection can be made prior to the search in the database on the basis of the at least one obtained item of identification information or, alternatively, the at least one item of contextual information, such that only entries or, alternatively, sensor data patches that correspond partially or fully with the at least one item of identification information or, alternatively, the at least one item of contextual information are taken into account during the search. As a result, the piecewise replacement can be accelerated.

In some embodiments, it is provided that the piecewise replacement of the obtained sensor data is carried out in consideration of respective temporally and/or spatially adjacent sensor data of the at least two sensors. As a result, a correlation between temporally and/or spatially adjacent sensor data can be taken into account during the piecewise replacement. In the example of a camera image, it may for example be taken into account that individual image sections of the camera image usually have a high correlation with (spatially) adjacent image sections of the camera image with regard to their properties. If a sequence of camera images is considered, an image section of a camera image usually also has a high correlation with the same image section of a (temporally) adjacent camera image with regard to the properties. This is utilized during the piecewise replacement to accelerate the process. In particular, it can be provided that entries or, alternatively, sensor data patches stored in the database are marked in relation to one another in terms of a temporal and/or spatial vicinity. In particular, the sensor data patches stored as entries in the database may be linked with other stored sensor data patches in terms of their temporal and/or spatial vicinity thereto. As a result, the comparison with the sensor data patches stored in the database can be accelerated. For example, it can be provided that, after a sensor data patch has been found for a segment from the sensor data of one of the at least two sensors, a preselection is made for other segments of the sensor data of the one of the at least two sensors. The preselection comprises the sensor patches that are below a predefined temporal and/or spatial distance from the already selected sensor data patch, i.e., those which are within a predefined temporal and/or spatial vicinity thereto.

Features relating to the design of the device are apparent from the description of embodiments of the method. The benefits of the device in this context are always the same as for the embodiments of the method.

In some embodiments, a method is also provided for operating an assistance system for a vehicle, wherein at least one function is provided for the automated or partially automated driving of a vehicle and/or for the sensing of the environment by means of the assistance system, wherein sensor data are recorded by means of at least two sensors, wherein a method according to one of the above-described embodiments is carried out, wherein the sensor data replaced piecewise are fed to the at least one function, and wherein the at least one function generates at least one control signal and/or evaluation signal based on the sensor data replaced piecewise and provides said signal.

In some embodiments, an assistance system is also provided for a vehicle, comprising at least two sensors, configured to record sensor data, and a device according to one of the above-described embodiments, wherein the assistance system is configured to provide at least one function for the automated or partially automated driving of the vehicle and/or for sensing the environment, wherein the at least one function generates at least one control signal and/or evaluation signal based on the sensor data replaced piecewise by means of the device and provides said signal.

A vehicle is, in particular, also provided, comprising at least one device and/or at least one assistance system according to one of the embodiments described. A vehicle is, in particular, a motor vehicle. In principle, however, the vehicle may be any other land, air, water, rail or space vehicle, for example a drone or an air taxi.

In the following, the invention is explained in greater detail based on further exemplary embodiments and with reference to the figures. Specific references to components, process steps, and other elements are not intended to be limiting. Further, it is understood that like parts bear the same or similar reference numerals when referring to alternate FIGS.

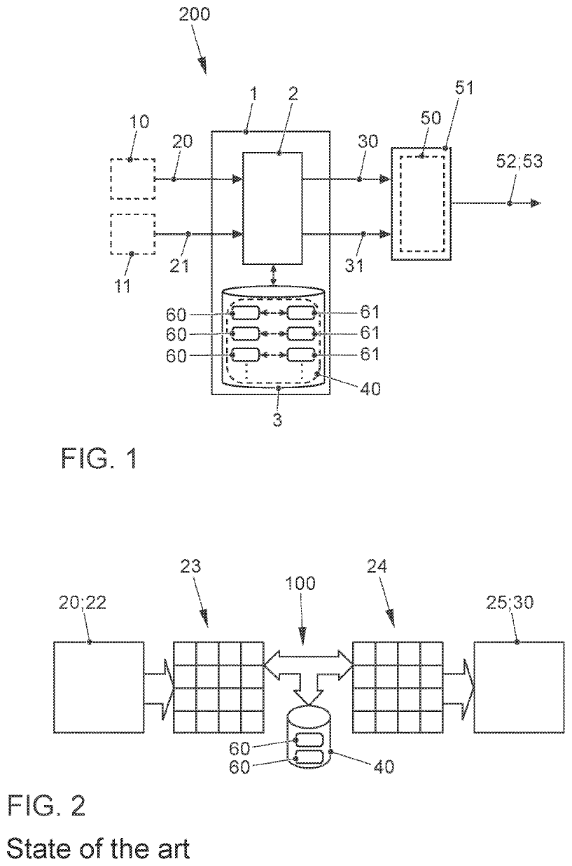

FIG. 1 is a schematic representation of an embodiment of the device 1 for making sensor data 20, 21 more robust to adversarial perturbations. The device 1 comprises a computing apparatus 2 and a memory apparatus 3. The device 1 can be used, in particular, in a vehicle, in particular a motor vehicle, in order to make input data of a neural network 50 used there more robust to adversarial perturbations. The device 1 carries out the method described in this disclosure for making sensor data 20, 21 more robust to adversarial perturbations.

Parts of the device 1, in particular the computing apparatus 2, can be designed separately or collectively as a combination of hardware and software, for example as program code which is executed on a microcontroller or microprocessor.

The device 1 or rather the computing apparatus 2 is fed sensor data 20, 21 from two sensors 10, 11. The sensors 10, 11 may, for example, be a camera and a lidar sensor.

The computing apparatus 2 obtains or rather receives the sensor data 20, 21 and replaces the sensor data 20, 21 piecewise by means of quilting. The piecewise replacement takes place in such a way that respective sensor data 30, 31 of the two sensors 10, 11 replaced piecewise are plausible relative to one another.

The sensor data 30, 31 replaced piecewise are then output by the computing apparatus 2. In particular, the sensor data 30, 31 replaced piecewise are then fed to an artificial neural network 50. The neural network 50 is provided by means of a control unit 51, for example in that a computing apparatus of the control unit 51 provides a functionality of the neural network 50 or, alternatively, performs computing operations required for providing the neural network 50. The neural network 50 in particular provides a function for the automated or partially automated driving of a vehicle and/or for sensing the environment. The function is, in particular, provided using an assistance system 200 comprising the sensors 10,11 and the device 1. For this purpose, the neural network 50 is trained to provide the function. The function provided by the neural network 50 generates at least one control signal 52 and/or evaluation signal 53 based on the sensor data 30, 31 replaced piecewise, which signal can be fed, for example, to actuators (not shown) of the vehicle and/or to at least one other control unit of the vehicle.

The sensor data 30, 31 replaced piecewise have the same format as the sensor data 20, 21 after the quilting or rather after the piecewise replacement, and therefore it is possible to integrate and use the device 1 in existing applications of sensors 10, 11 and neural networks 50.

In particular, it is provided that a database 40 having sensor data patches 60, 61 generated from sensor data of the sensors 10, 11 is provided for the quilting, wherein the sensor data patches 60, 61 of the sensors 10, 11 are linked with one another in the database 40 in such a way that the respectively linked sensor data patches 60, 61 are plausible relative to one another. The database 40 is stored in the memory apparatus 3, for example.

For this purpose, the database 40 was created previously, in particular using trustworthy recorded sensor data of the two sensors 10, 11, in that a large number of interlinked sensor data patches was generated from the recorded trustworthy sensor data. “Trustworthy” should, in particular, be understood to mean that it is certain that the recorded sensor data contain no adversarial perturbations. If the trustworthy sensor data are camera images or lidar data, for example, it can be provided that a sensor data patch 60, 61 in each case comprises a segment of 8×8 pixels of a camera image and a corresponding segment from the lidar data of 8×8 measuring points. The sensors used or, alternatively, the trustworthy sensor data are, in particular, temporally and spatially calibrated with one another.

For the piecewise replacement during the quilting, the computing apparatus 2 in particular proceeds as follows. The sensor data 20, 21 are in each case split into segments. The segments are in each case compared with the sensor data patches 60, 61 stored in the database 40. Based on a distance measure, for each segment, the sensor data patch 60, 61 that has the shortest distance from the relevant segment is searched for. For this purpose, the sensor data 20, 21 comprised by the relevant segment and the sensor data comprised by the sensor data patches 60, 61 are expressed in each case as vectors, for example. A distance between said vectors can then be determined using the distance measure, for example the L2 norm, and the determined distances can be compared with one another. Once the sensor data patch 60, 61 with the shortest distance from the segment in question is found, the segment in the sensor data 20, 21 is replaced by said sensor data patch and provided as replaced sensor data 30, 31. Since the sensor data patches 60, 61 for the two sensors 10, 11 are linked with one another in the database 40, the sensor data 20, 21 of the two sensors 10, 11 are replaced by the linked sensor data patches 60, 61. On account of the use of the linked sensor data patches 60, 61, the replaced sensor data 30, 31 of the two sensors 10, 11 are made plausible relative to one another.

It can be provided that a selection of sensor data patches 60, 61 used during the quilting is made for the two sensors 10, 11 based on the sensor data 20, 21 of only a portion of the sensors 10, 11. For example, the selection may be made based solely on the sensor data 20 of the sensor 10. Since the sensor data patches 60, 61 are linked with one another, a sensor data patch 60, which was found based on the sensor data 20, can be used to immediately identify the sensor data patch 61 for the sensor data 21.

It can be provided that the piecewise replacement of the obtained sensor data 20, 21 is carried out in consideration of respective temporally and/or spatially adjacent sensor data 20, 21 of the at least two sensors 10, 11. In particular, the sensor data patches 60, 61 can be linked with one another or, alternatively, marked in the database 40 with regard to a temporal and/or spatial vicinity. As a result, a preselection in which a temporal and/or spatial correlation is taken into account upon occurrence of the sensor data 20, 21 represented by the sensor data patches 60, 61 can already be made when searching for a sensor data patch 60, 61.

It is provided, in particular, that the obtained sensor data 20, 21 are sensor data that are recorded and/or output for a function for the automated or partially automated driving of a vehicle and/or for detecting the environment and/or sensing the environment.

If more than two sensors 10, 11 are present, the method is carried out for all sensors 10, 11 in an analogous manner. In particular, the replaced sensor data 30, 31 of all sensors 10, 11 are plausible relative to one another after the method has been performed. In particular, it can be provided that sensors other than a camera and a lidar sensor are alternatively or additionally also used.

FIG. 2 is a schematic representation for illustrating the quilting from the prior art based on the example of a camera image 22. Sensor data 20, in the present case a camera image 22, are split into segments 23. For each of the segments 23 of the camera image 22, a search is carried out in a database 40 within the scope of a quilting step 100 for a sensor data patch 60 that has the shortest distance from the segment 23 with respect to a distance measure. In the present case, a sensor data patch 60 is an image section that has the size of the segments 23, i.e. the same number of pixels. The distance measure is, for example, the L2 norm, which is applied to vectors generated by means of linearization of the image sections. In the quilting step 100, each segment 23 is then replaced by the relevant sensor data patch 60 with the shortest distance therefrom. In this connection, it can be provided that a minimum distance must be adhered to. All segments 23 are replaced by sensor data patches 60 from the database 40 in this way. This creates replaced segments 24 which together form the replaced sensor data 30 or rather replaced camera image 25.

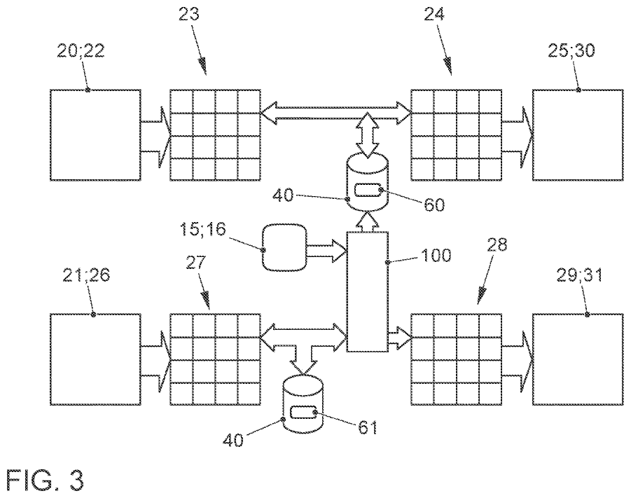

FIG. 3 is a schematic representation for illustrating the quilting according to an embodiment of the method described in this disclosure based on the example of sensor data 20 in the form of a camera image 22 and sensor data 21 in the form of lidar data 26. The quilting itself takes place in the same way as already described above in connection with FIG. 2. However, the piecewise replacement is carried out in such a way that respective replaced sensor data 30, 31 of the sensors, i.e., of the camera and lidar sensor, are plausible relative to one another. For this purpose, plausibilization additionally takes place in the quilting step 100. In particular, sensor data patches 60, 61 are determined or, alternatively, selected from the database 40 within the scope of this quilting step 100 in such a way that the sensor data patches 60, 61 are plausible relative to one another. In the present example, this in particular means that the replaced segments 24 of the sensor data 20 of the camera correspond in a physically plausible manner with the respective replaced segments 28 of the lidar data 26. Put simply, the replaced segments 24, 28 or rather the replaced camera image 25 and the replaced lidar data 29 must be consistent with one another and may not contradict one another in terms of content or rather physically. For example, a scene depicted in the replaced camera image 25, in particular, must fit together in a plausible manner with a depth profile of the replaced lidar data 29.

For this purpose, it is in particular provided that the sensor data patches 60, 61 are stored in the database 40 so as to already be linked with one another. For example, the database 40 may be created before the method described in this disclosure is carried out, in that sensor data patches 60, 61 are generated at the same time for both (or more) sensors, wherein respective segments are generated from simultaneously recorded trustworthy sensor data and are deposited as sensor data patches 60, 61 in the database 40 in each case together or rather so as to be linked with one another. For example, the individual segments may be combined in each case into a common vector for both sensors and stored as a common or rather linked sensor data patch 60, 61.

It can additionally be provided that at least one item of identification information 15 is obtained, wherein the piecewise replacement in the quilting step 100 additionally takes place in consideration of the at least one obtained item of identification information 15. For example, during the search in the database 40, a preselection of sensor data patches 60, 61 is made based on the obtained item of identification information 15, such that the search for the sensor data patch 60, 61 with the shortest distance can be accelerated.

In some embodiments, it can be provided that the obtained item of identification information 15 is or has been derived from an item of contextual information 16 relating to an environment in which the sensor data 20, 21 of the sensors are or were recorded. An item of contextual information 16 may, for example, be a geographical coordinate (e.g., GPS coordinate), a time of day and/or year, a month, a day of the week, a weather condition (sun, rain, fog, snow, etc.) and/or a traffic context (city, countryside, highway, pedestrian zone, country road, main road, side road, etc.). An item of contextual information 16 of this kind may, for example, be recorded by means of at least one context sensor or be provided in another way. In a vehicle, contextual information can, for example, be queried via a controller area network (CAN) bus in a vehicle control system. By means of the item of contextual information 16, it is possible, for example, to make a preselection of sensor data patches 60, 61, such that the search for the next sensor data patch 60, 61 can be accelerated. For this purpose, it is provided that the sensor data patches 60, 61 have been or, alternatively, are stored in the database 40 so as to be marked (“tagged”) with an associated form of the item of contextual information in each case.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module, or other unit or device may fulfill the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

### LIST OF REFERENCE NUMERALS

1 Device
2 Computing apparatus
3 Memory apparatus
10 Sensor (camera)
11 Sensor (lidar sensor)
15 Item of identification information
16 Item of contextual information
20 Sensor data
21 Sensor data
22 Camera image
23 Segment
24 Replaced segment
25 Replaced camera image
26 Lidar data
27 Segment
28 Replaced segment
29 Replaced lidar data
30 Replaced sensor data
31 Replaced sensor data
40 Database
50 Neural network
51 Control unit
52 Control signal
53 Evaluation signal
60 Sensor data patch
61 Sensor data patch
100 Quilting step
200 Assistance system

What is claimed is:

1. A method for making sensor data more robust to adversarial perturbations,
comprising:
obtaining sensor data from at least two sensors;
replacing the sensor data obtained from the at least two sensors in each case piecewise using quilting, wherein the piecewise replacement is carried out in such a way that the respectively replaced sensor data from different sensors are plausible relative to one another; and
outputting the piecewise replaced sensor data.

2. The method of claim 1, wherein the sensor data replaced piecewise are fed to at least one function for automated or partially automated driving of a vehicle and/or for sensing the environment.

3. The method of claim 1, wherein a database having sensor data patches generated from sensor data of the at least two sensors is provided for the quilting, wherein the sensor data patches of the at least two sensors are linked with one another in the database in such a way that the respectively linked sensor data patches are plausible relative to one another.

4. The method of claim 3, wherein a selection of sensor data patches used during the quilting is made for the at least two sensors based on the sensor data of only a portion of the at least two sensors.

5. The method of claim 1, wherein at least one item of identification information is obtained, wherein the piecewise replacement during the quilting additionally takes place in consideration of the at least one obtained item of identification information.

6. The method of claim 5, wherein the obtained item of identification information is or has been derived from an item of contextual information relating to an environment in which the sensor data of the at least two sensors are or were recorded.

7. The method of claim 1, wherein the piecewise replacement of the obtained sensor data is carried out in consideration of respective temporally and/or spatially adjacent sensor data of the at least two sensors.

8. A method for operating an assistance system for a vehicle, comprising:
providing at least one function for the automated or partially automated driving of the vehicle and/or for sensing the environment using the assistance system;
recording sensor data using at least two sensors;
carrying out the method of claim 1; and
feeding the piecewise replaced sensor data to the at least one function, wherein the at least one function generates at least one control signal and/or evaluation signal based on the sensor data replaced piecewise and provides said signal.

9. A device for making sensor data more robust to adversarial perturbations, comprising a computing apparatus,
wherein the computing apparatus is configured to obtain sensor data from at least two sensors,
to replace the sensor data obtained from the at least two sensors in each case piecewise by means of quilting, and to carry out the piecewise replacement in such a way that respectively replaced sensor data from different sensors are plausible relative to one another, and to output the sensor data replaced piecewise.

10. An assistance system for a vehicle, comprising:
at least two sensors, configured to record sensor data; and
the device of claim 9;
wherein
the assistance system is configured to provide at least one function for the automated or partially automated driving of the vehicle and/or for sensing the environment;
wherein the at least one function generates at least one control signal and/or evaluation signal based on the sensor data replaced piecewise using the device and provides said signal.

11. A non-transitory medium with a computer program, comprising commands which, upon execution of the computer program by a computer, prompt said computer to execute the method of claim.

12. A data carrier signal, which transmits the computer program according to claim 11.

13. The method of claim 2, wherein a database having sensor data patches generated from sensor data of the at least two sensors is provided for the quilting, wherein the sensor data patches of the at least two sensors are linked with one another in the database in such a way that the respectively linked sensor data patches are plausible relative to one another.

14. The method of claim 2, wherein at least one item of identification information is obtained, wherein the piecewise replacement during the quilting additionally takes place in consideration of the at least one obtained item of identification information.

15. The method of claim 3, wherein at least one item of identification information is obtained, wherein the piecewise replacement during the quilting additionally takes place in consideration of the at least one obtained item of identification information.

16. The method of claim 4, wherein at least one item of identification information is obtained, wherein the piecewise replacement during the quilting additionally takes place in consideration of the at least one obtained item of identification information.

17. The method of claim 2, wherein the piecewise replacement of the obtained sensor data is carried out in consideration of respective temporally and/or spatially adjacent sensor data of the at least two sensors.

18. The method of claim 3, wherein the piecewise replacement of the obtained sensor data is carried out in consideration of respective temporally and/or spatially adjacent sensor data of the at least two sensors.

19. The method of claim 4, wherein the piecewise replacement of the obtained sensor data is carried out in consideration of respective temporally and/or spatially adjacent sensor data of the at least two sensors.

20. The method of claim 5, wherein the piecewise replacement of the obtained sensor data is carried out in consideration of respective temporally and/or spatially adjacent sensor data of the at least two sensors.
